(19) United States
(12) Patent Application Publication
(10) Pub. No.: US 2025/0079945 A1
(43) Pub. Date: Mar. 6, 2025

(54) Electronic Drive for Motor with Even Number of Phases

(71) Applicant: Phillip Gerard Langhorst, Saint Louis, MO (US)

(72) Inventor: Phillip Gerard Langhorst, Saint Louis, MO (US)

(21) Appl. No.: 18/814,767

(22) Filed: Aug. 26, 2024

Related U.S. Application Data
(60) Provisional application No. 63/535,329, filed on Aug. 30, 2023.

(51) Int. Cl. H02K 11/02; H02K 11/33

(52) U.S. Cl. CPC H02K 11/02; H02K 11/33; H02K 2211/03

(57) ABSTRACT

Electric motors are controlled by electronic circuits called variable speed drives which supply the motor with adjustable voltage and adjustable frequency to power the motor at its best operating point. Variable speed drives output rectangular pulses of voltage to the motor. The fast edge of these pulses produce unwanted electrical noise called electromagnetic interference (EMI). The invention consists of a motor with an even number of phases and a balanced drive circuit to reduce electromagnetic interference (electrical noise). By using an even number of phases, one phase will be going negative at the exact instant another phase is going positive, and the noise current can flow across windings but not back to the supply. This will greatly reduce unwanted current and EMI in the frame of the system.

### FIELD OF THE INVENTION

Electric motors are often controlled by electronic circuits called variable speed drives. These circuits are capable of supplying the motor with adjustable voltage and adjustable frequency in order to power the motor at its best operating point. The variable speed drive however creates much unwanted electronic interference. The drive's voltage output has fast transitions which are the source of this interference.

Large motors normally need a variable speed drive with very many transistor switches in parallel. The modules which contain so many parallel switches are less available in the market and fewer choices are possible.

### BACKGROUND OF THE INVENTION

A variable speed drives gives the owner the able to change the motor's speed to match another process, such as a conveyor or air conditioning coil. By getting the voltage and frequency to the best possible point, the motor will be more efficient, saving the owner energy cost.

The transistors in the variable speed drive or either on or off. As a consequence, the output voltage of the drive is a rectangular pulse of voltage, not a triangular or sinusoidal. The pulses have very fast transitions and such high dV/dt causes significate current in any capacitance connected to the drive's output. A problem occurs because the motor has significate capacitance from its winding to its frame. The drive output, which is connected to the windings, will drive significate current through this capacitance into the motor's frame. This current will flow back to the supply via any possible path connected to the motor's frame including the chassis of the machine its driving. Such currents are unwanted, they generate electrical noise that interferes with other circuits and other nearby sensitive equipment such as radar, EKG, radios, GPS, etc. These emissions are regulated by government bodies such as the FCC. Controlling and minimizing this frame current and its associated emissions is a major part of the cost in a variable speed drive.

Another problem arises in variable speed drives as the power rating is increased. To order to carry the high current required for a large drive that might be tens or hundreds of horsepower, many transistors are normally connected in parallel. Such transistors must be individually matched to the others in parallel. Several of these parallel groups are often packaged into “modules” of 2, 4, or 6 to facilitate the bridge connection necessary for driving an AC motor. Matching raises cost. The uniqueness of the module makes it specialty item which generally cost more per watt than individual transistors.

The following invention solves both problems by driving phase pairs using individual transistors to.

### DESCRIPTION OF THE PRIOR ART

Virtual all variable speed drives on the market today are used in connection with 3 phase motors. The three-phase system was invention initial by Nicola Tesla around 1880. The entire motor and generator industry has developed around 3 phase power.

Designers have devised methods to cope with the frame current that is inherent in the 3 phase system. Existing 3 phase variable speed drives generally have a multitude of inductors and capacitors arranged as an EMI filter in order to reduce the frame current and to by-pass the frame current into a local capacitor. This filter is in an effort to keep the current from flowing in the system's chassis back to the supply.

The transistors in variable speed drives also create unwanted current into the drive's heatsink and can enter the system's chassis. The same EMI filter is normally effective in reducing this unwanted current as well.

### SUMMARY OF THE INVENTION

The present invention consists of a particular arrangement of transistors, diodes, capacitors, and connectors arranged to supply two phases of motor having an even number of phases. For the purpose of description, we will call these two phases A and A′ (A prime). The two phases are driven 180 degrees apart, meaning one phase, A, is provided with positive voltage with respect to the motor's neutral at the same instant the other phase, A′, is provided with negative voltage.

The main (fundamental) driving current will flow from phase A and though phase A′, and in conjunction with the other phases, will cause the motor to spin.

Some unwanted current will flow into the frame from phase A, but an equal amount, at the same instant, will flow out of the frame and into phase A′, (because A′ has negative voltage applied). The net result is that little to no current will flow out of the frame into the chassis of the system.

The present invention consists of 4 transistors forming two legs of an H bridge. The two phases are connected in the center of the legs. Capacitor are connected to the positive and negative supply busses. The capacitors are required to absorb the reactive energy of the windings. Diodes are connected across each transistor to provide a freewheeling path for winding current when the opposite transistor on the same leg is turned off. Some transistor types such as MOSFETs have these diodes as an integral part of the transistor.

Motor with high phase counts are especially suitable to be attached to the present invention. 6 phases, 12, 15, 18, 24, and 30 phase motors can be employed. The compactness of the drive circuit allows many phases to be driven in a relatively small space. The present invention lends itself to high power system because the load is distributed among many transistors which makes is easier to cool the transistors because the heat is spread over a wider area. Systems of 100 KW, 200 kW, even 500 kW could be effectively done with this approach.

The present invention also lends itself to the use of individual transistors rather than transistor modules. Modules are packs containing several transistors in parallel in a bridge configuration. Modules are generally more expensive per kW than individual transistors. There are also fewer companies that make modules and this leads to a shortage of supply at times. The present invention, being comprised of individual transistors, will suffer less supply shortages.

The present invention also allows the designer the freedom to choose from a wider variety of transistors and freewheel diodes than if modules were employed. The freewheeling diode, captures the current after a transistor is switched off and must be “recovered” when the transistor turns back on. The process of recovery involves current flowing backward into the diode to reestablish the depletion zone so the diode can support voltage. The best diodes for this function are silicon carbide because they require little to no recovery current. Many times, the companies who offer modules do not use silicon carbide diodes. Since the designer of the present invention does not have to use modules, he is free to find and use silicon carbide diodes and gain the advantage they have of additionally lower switching losses.

By using discrete transistors, a four-switch bridge can be constructed to drive two of the opposite phases, four switches for A-A′, four switches for B-B′, four switches for C-C′, etc. This arrangement allows very close proximity of the conductors carrying current from the DC buss capacitor to the winding and back, resulting in a small, tight, loop which will not radiate much electromagnetic interference (EMI).

The four transistors bridge is a very compact circuit and can be located in close proximity to the windings resulting very little conductor lead length and very little area for EMI to radiate from.

The present invention provides for “phaseblocks”, each which are a four-transistor switch bridge and its associated bus capacitor(s). The phaseblocks being positioned above, or behind, the associated motor windings. The present invention also provides for multiple phaseblocks on a common substrate being fed by common power rails. The rails would receive power from the mains, a battery, a generator, solar panels, or a combination of sources. The phaseblocks may be deployed in groups of 3 or 5 positioned about the motor. All phaseblocks for a given motor could optionally be fixed to one common substrate, in a plate or cylinder configuration, behind or around the motor. Flat plates containing several phaseblocks could be positioned around the motor.

Note that in and even phase motor, is it not necessary to have an even number of motor teeth, the phases which are opposite (i.e. 1 and 16 in a 30 phase motor) can have two windings on the same tooth. It best to stack the winding rather than have them in concentric shells because a stacked configuration will give both windings equal capacitance to the motor's frame and less current will leave the frame to the motor's mountings.

It is best to have the phaseblocks feed power into the center of the winding. The capacitive current conducts most effectively into the frame at the beginning of the winding. This is because the inductance of the winding can block current flow to the end of the winding. By placing the power feed in the center of the winding, the portion of the motor's frame which is carrying capacitive current will be minimized.

### BRIEF DESCRIPTION OF THE DRAWINGS

In referring to the drawings:

FIG. 1 is a schematic view of a 3-phase motor.

The same reference numerals refer to the same parts throughout the various figures.

FIG. 2 is a schematic view of a 6-phase motor.

FIG. 3 is an embodiment of the Invention with the phaseblocks shown schematically and the motor windings shown in a portion of the end view of the motor.

FIG. 4 is an embodiment of the Invention with the phaseblocks shown in plan view and the motor windings shown in a portion of the end view of the motor. All which are of parts the Invention.

FIG. 5 is an embodiment of the Invention shown in an end view of a motor showing the positions of three phaseblocks. The buss conductors are removed for clarity.

FIG. 6 is an embodiment of the Invention shown in a side view of a motor, showing the positions of three phaseblocks along the length of the motor. The buss conductors are shown wrapping around the motor.

FIG. 7 is the view of a 30 phase motor shown schematically.

### DETAILED DESCRIPTION OF THE INVENTION

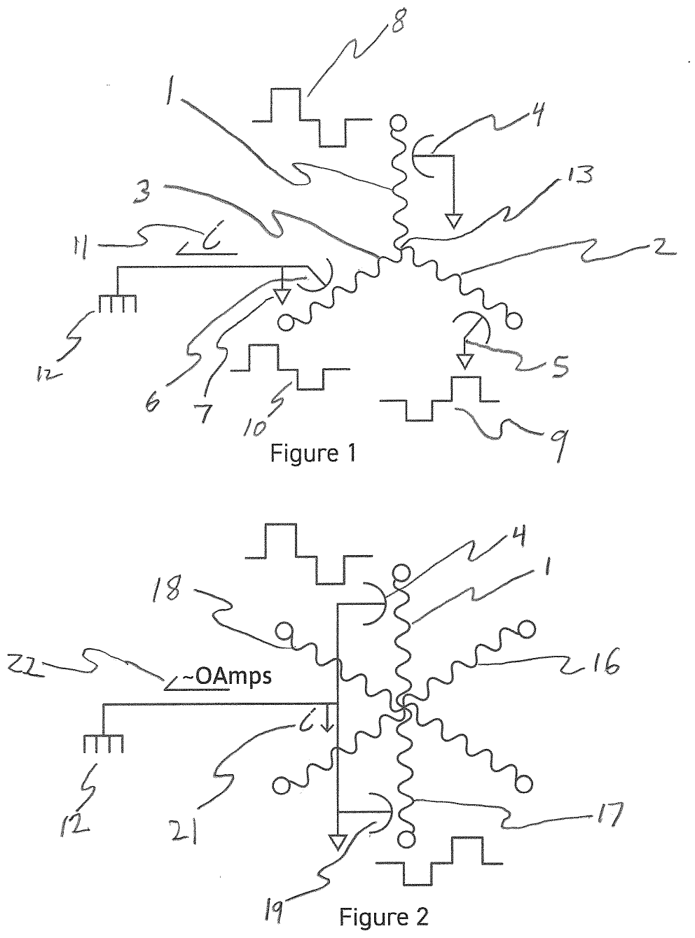

In FIG. 1 there is shown is a schematic view of a 3-phase motor with phase windings 1, 2, and 3 positioned at 120 degrees. Capacitance 4, 5, and 6 exist between the windings 1,2,3 and the frame show schematically as the inverted triangle 7. As voltage pulses 8, 9, and 10 are applied, current 11 will flow from the winding 3 and through the capacitor 6 to the frame 7 and then through connections between the frame to the chassis of the equipment shown schematically as the earth symbol 12. Similar currents are not shown but will flow through the capacitors 4 and 5 to the motor's frame and then into the chassis. The motor has a neutral point 13.

FIG. 2 is schematic view of a 6-phase motor with phase similar windings to FIG. 1 but with additional windings 16, 17, and 18 positioned at 60, 180, and 300 degrees. Capacitance 4 and 19, exists between the windings 1 and 17. As voltage pulse 10 is applied to winding 1 an identical pulse but opposite in polarity 20 is applied to winding 17. The current 21 will flow from the capacitance 4 to the capacitance 19. Because the impedance is balanced and the applied voltage is equal and opposite with respect the frame, no current 22 (or very little) will flow into the chassis 12.

By comparing FIG. 1 and FIG. 2 it can be seen that having an even number of phases guarantees that there will always be phases 180 degrees apart, and no phase will contribute to current into the chassis.

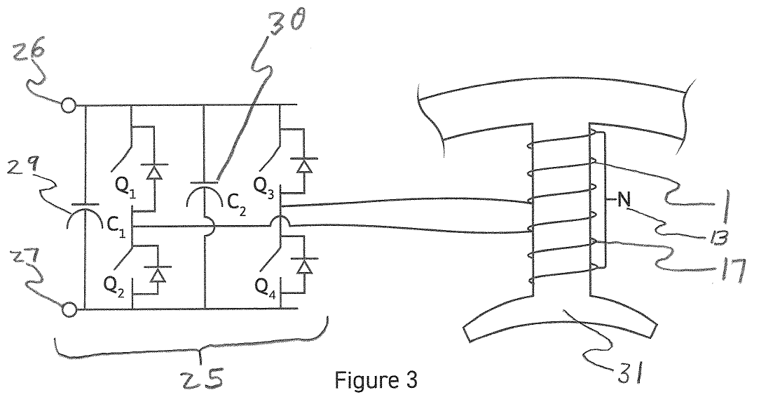

FIG. 3 shows an embodiment of the invention. A PhaseBlock, 25, comprised of four transistor, is shown schematically to the left of one tooth 31 of a motor having windings 1 and 17. Positive DC power is connected at terminal 26. Negative DC power is connected at terminal 27. Transistor Q1 is connected in series with transistor Q2 across the DC bus. The center point between Q1 and Q2 is connected to winding 17. Transistor Q3 is connected in series with transistor Q4 across the DC bus. The center point between Q3 and Q4 is connected to winding 17. Turning on Q1 and Q4 creates downward flux in the motor tooth 28. Turning on Q3 and Q2 creates downward flux in the motor tooth 28. The transistor pairs Q1,Q4 and Q2,Q3 always switch in pairs resulting in balanced voltage applied to the coils. Capacitors 29 and 30 provide local stored charge so that energy can be shifted in and out of the coils quickly without charge having to come from the DC supply.

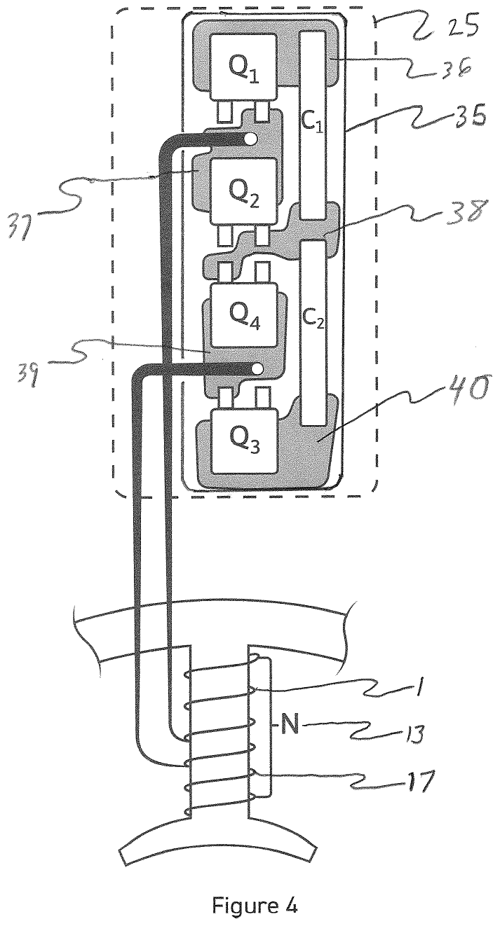

FIG. 4 shows an embodiment of the invention. A phaseblock, 25, comprised of four transistors, Q1, Q2, Q3, Q4 is shown in a plan view above one tooth of a motor having windings 1 and 17. The components of the phaseblock 25 are the same Transistor Q1, Q2, Q3, Q4 and capacitor as those show schematical in FIG. 3. The phaseblock 25 is designed to be compact and narrow to facilitate many phaseblocks placed side by side. The components of the phaseblock can be mounted on a common substrate 35 such as a Printed Circuit board (PCB) or Insulated metal substrate (IMS). The phase block is mounted in close proximity to motor winding 1 and 17. The substrate has area of conductor 36,37,38,39, and 40 which connect the components electrically. The Capacitors C and C2 are shown of similar size to the transistors but in some situations these capacitor need to much larger and cover most of the area of the substrate 35.

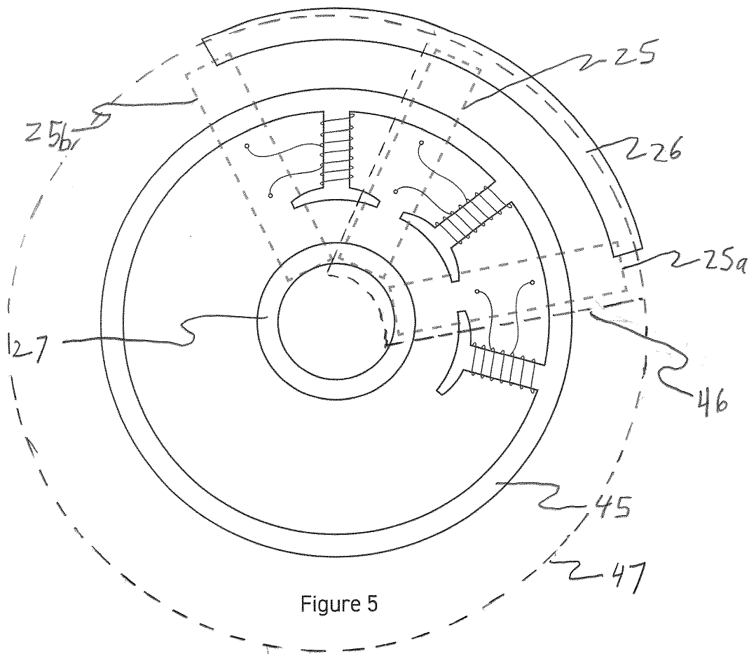

FIG. 5 shows the end of a motor with two different embodiments of the invention attached to it. Only three of the teeth of the motor are shown but it might have many more. A subset of necessary phaseblocks 25, 25a, and 25b are shown position circumferentially around the end of the motor 45 and connected to the motor's windings. Conducting bars 26 and 27 carry positive DC power to the phaseblocks. A conducting bar, not shown, carries negative DC power to the center of the phaseblocks. Such an arrangement can hold many phaseblocks in a small space behind the motor. In one embodiment, the transistors of a sub group of phaseblocks such as 25 and 25a can be mounted on common substrate 46, and several of these groups can be used to connect to all the windings of the motor. In a second embodiment, an even larger substrate 47 can be used to mount all the transistors of all the phaseblocks. Such an embodiment would be the most compact and cost effective. In order to make the electronics removable from the motor connector not shown can be use on the wires between the phaseblocks and the windings.

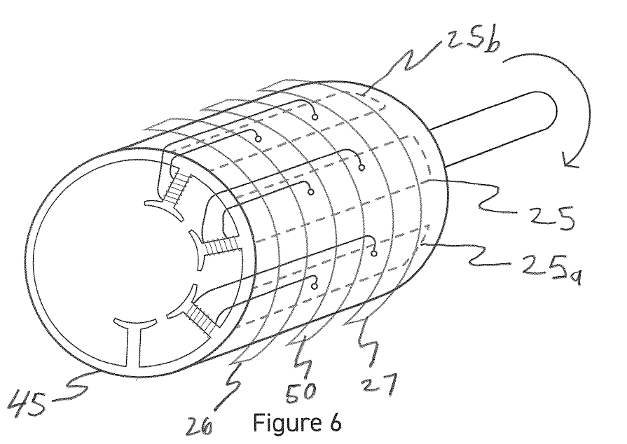

FIG. 6 shows a motor with an embodiments of the invention attached to it. Only three of the teeth of the motor are shown but it might have many more. A subset of necessary phaseblocks 25, 25a, and 25b are shown position laterally around the motor 45 and connected to the motor's windings. Conducting bars 26 and 27 carry positive DC power to the phaseblocks. A conducting bar 50 carries negative DC power to the center of the phaseblocks. Such an arrangement can hold many phaseblocks around the periphery of a motor. In order to make the electronics removable from the motor connector not shown can be use on the wires between the phaseblocks and the windings.

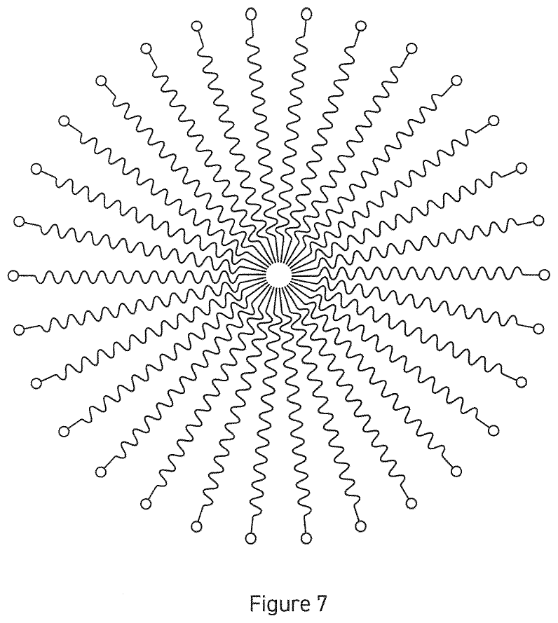

FIG. 7 shows the winding diagram of a 30 phase motor which could be driven by the present invention.

As various modifications could be made to the exemplary embodiments as described above with reference to the corresponding illustrations, without departing from the scope of the Invention, it is intended that all matter contained in the foregoing description and shown in the accompanying drawings shall be interpreted as illustrative rather than limiting. Thus, the breadth and scope of the present Invention should not be limited by any of the above-described exemplary embodiments, but should be defined only in accordance with the following claims appended hereto and their equivalents.

What is claimed:

1. A circuit for supplying two phases of power to a motor having an even number of phase windings comprising:
a first phase winding providing positive magnetic flux when positive voltage is applied with respect to the motor's neutral,
a second phase winding providing positive magnetic flux when a negative voltage is applied with respect to the motor's neutral,
a first and second transistor, connected in series, forming a first leg of an H-bridge circuit,
a third and fourth transistor, connected in series, forming a second leg of an H-bridge circuit,
wherein said first phase winding is connected in the center of said first leg,
wherein said second phase winding is connected in the center of said second leg,
wherein said first phase and said second phase windings are connected in series at the motor's neutral,
wherein said third, and fourth transistors are controlled to apply voltage to said second winding of equal and opposite polarity of the voltage that said first and second transistors apply to said first phase.

2. The circuit of claim 1 further comprising:
another four switch H bridge driving a third phase and a fourth phase.

3. The circuit of claim 1 further comprising:
said first phase and said second phase windings mounted adjacent to each other on the same magnetic pole,
Wherein said connection of said first phase winding to said first and second transistors is made between said first phase at the point in closest physical proximity to said second phase winding,
Wherein said connection of said second phase winding to said third and fourth transistors is made to said second phase windings at the point in closest physical proximity to said first phase winding.

4. A phaseblock comprising:
a four-transistor H-bridge circuit,
a capacitor connected to the DC bus of the bridge,
wherein the phaseblock is disposed above an associated motor winding.

5. A variable frequency drive circuit comprising:
a first phaseblock,
a second phaseblock,
a common substrate on which is mounted said first phaseblock and said second phaseblock, a common electrically conductive rail connected to said first and second phaseblocks, wherein said common rail is connect to an electrical source.
